(19) United States
(12) Patent Application Publication
(10) Pub. No.: US 2025/0018413 A1
(43) Pub. Date: Jan. 16, 2025

(54) APPLICATION SYSTEM AND ASSOCIATED MONITORING METHOD

(71) Applicant: Dürr Systems AG, Bietigheim-Bissingen (DE)

(72) Inventors: Nico Koch, Tamm (DE); Paul Thomä, Sachsenheim (DE); Dmitri Noak, Stuttgart (DE); Kevin Kurzenberger, Sachsenheim (DE)

(21) Appl. No.: 18/716,162

(22) PCT Filed: Jan. 2, 2023
(86) PCT No.: PCT/EP2023/050008

§ 371 Date: Jun. 4, 2024

(30) Foreign Application Priority Data
Jan. 10, 2022 (DE) 10 2022 100 401.5

(51) Int. Cl. B05B 12/08; B05B 12/00; B05B 15/50

(52) U.S. Cl. CPC B05B 12/087; B05B 12/006; B05B 15/50

(57) ABSTRACT

The disclosure relates to an application system for applying an application agent (e.g. sealant) to a component (e.g. motor vehicle body component). The application system according to the disclosure comprises an applicator with at least one nozzle, a supply line for supplying the applicator with the application agent, a sensor which measures a measured variable in the supply line to the applicator or in the applicator and supplies a corresponding sensor signal, and a monitoring unit which is connected to the sensor and evaluates the sensor signal of the sensor. The disclosure provides that the monitoring unit recognizes, by evaluating the sensor signal, whether one of the nozzles of the applicator shows a creeping nozzle clogging.

### CROSS-REFERENCE TO RELATED APPLICATIONS

This application is a national stage of, and claims priority to, Patent Cooperation Treaty Application No. PCT/EP2023/050008, filed on Jan. 2, 2023, which application claims priority to German Application No. DE 10 2022 100 401.5, filed on Jan. 10, 2022, which applications are hereby incorporated herein by reference in their entireties.

### TECHNICAL FIELD

The disclosure relates to an application system for applying an application agent to a component, in particular for applying a sealant, an insulating material or an adhesive to a motor vehicle body component.

### BACKGROUND

In modern paint shops for painting vehicle body components, not only paint is applied to the vehicle body components. In addition, so-called sheet metal seam sealing is also carried out for corrosion protection, for example, in which a sealant is applied to sheet metal seams. Here, an application robot guides an applicator with a nozzle along the respective sheet metal seam, whereby the applicator then applies the sealant to the sheet metal seam. Several application robots are usually used simultaneously in an application booth, each guiding an applicator.

It is also known from the prior art to use applicators that each have three nozzles for different applications, whereby such applicators are marketed by the applicant under the product name “EcoGun2 3D”. During operation of such an applicator, creeping nozzle clogging can occur at the nozzles of the applicator, which must be distinguished from sudden nozzle clogging. For example, sudden nozzle clogging can occur due to material chips that suddenly clog a nozzle. Such sudden nozzle clogging is relatively easy to detect. More problematic, however, is creeping nozzle clogging that occurs slowly during application and is caused by material hardening and deposits on the nozzle walls. This creeping nozzle clogging can occur within hours or days during application operation and lead to a change in the nozzle geometry, whereby the jet of sealant emitted becomes thinner, swirled or deflected, which then requires cost-intensive manual reworking of the vehicle body components.

Reference should also be made to WO 2021/047 753 A1, JP 6 733 830 B1, US 2018/0 281 012 A1, JP 2007-260 531 A, EP 1 658 145 B1, U.S. Pat. No. 4,894,252 A, EP 2 922 640 B1, U.S. Pat. No. 4,822,647 A and US 2019/0 232 320 A1.

The disclosure is therefore based on the task of detecting creeping nozzle clogging in an application system in order to be able to take countermeasures in good time.

### BRIEF DESCRIPTION OF THE DRAWINGS

FIG. 1 shows a schematic representation of an application system according to the disclosure with four robot-guided applicators.

FIG. 2 shows a schematic representation of an applicator with three nozzles and a supply line as well as a monitoring unit for detecting a creeping nozzle clogging in one of the nozzles.

FIG. 3 shows a diagram to illustrate the different progression of the residual values of the sensor signals at the nozzles of the applicator according to FIG. 1.

FIG. 4 shows a flow chart illustrating the training process of the machine learning algorithm in an application system according to the disclosure.

FIG. 5 shows a flow chart illustrating the actual application mode of an application system according to the disclosure.

FIG. 6 shows a modification with four supply lines for supplying one applicator each, whereby the applicators each have only one nozzle.

### DETAILED DESCRIPTION

The disclosure relates to an application system for applying an application agent to a component, in particular for applying a sealant, an insulating material or an adhesive to a motor vehicle body component. The disclosure is therefore not limited to sealants with regard to the type of application agent, but can also be realized with other types of application agents. Furthermore, the disclosure is also not limited to motor vehicle body components with regard to the type of components to be coated, but can in principle also be realized with other types of components.

In accordance with the state of the art, the application system according to the disclosure comprises at least one applicator which serves to apply the application agent (e.g. sealant, insulating material, adhesive) to the component (e.g. motor vehicle body component).

In a preferred variant of the disclosure, the applicator comprises several nozzles, for example three nozzles, in accordance with the known applicator “EcoGun2 3D” described above. The disclosure then enables the detection of a creeping nozzle clogging in one of the nozzles of the applicator.

In another variant of the disclosure, on the other hand, it is provided that a plurality of applicators are each provided with at least one nozzle, in which case the disclosure makes it possible to detect a creeping nozzle clogging in one of the applicators.

These two variants of the disclosure (at least one applicator with several nozzles or several applicators each with at least one nozzle) are described separately below.

In addition, the disclosure has at least one supply line to supply the applicator with the application agent. In the variant of the disclosure with several applicators briefly mentioned above, several supply lines are then also provided, which are assigned to the individual applicators, as will be described in detail. In the preferred variant of the disclosure, however, one applicator with several nozzles is provided, which is supplied with the application agent by a single supply line.

Furthermore, in accordance with the known application systems described at the beginning, the application system according to the disclosure comprises at least one sensor which measures a measured variable in the supply line to the applicator or in the applicator and supplies a corresponding sensor signal. For example, the sensor can measure the pressure of the application agent in the supply line or the flow rate (e.g. volumetric flow) flowing in the supply line to the applicator.

The disclosure works well with volumetric metering. The volumetric flow does not really have to be measured directly, but can be calculated. The volumetric flow results from the displacement of the sealing material in the piston dispenser, which in turn is driven by a servomotor. The measurement takes place in the servomotor (control of the speed or position), so that the volumetric flow can then be derived from the measured speed.

Furthermore, in accordance with the known application systems described at the beginning, the application system according to the disclosure also comprises a monitoring unit which is connected to the sensor and evaluates the sensor signal from the sensor.

In the prior art, the monitoring unit only has the task of controlling the operation of the application system and ensuring that specified application parameters (e.g. pressure of the application agent) are maintained as precisely as possible. The disclosure now provides for the monitoring unit to detect whether one of the nozzles shows a creeping nozzle clogging by evaluating the sensor signal.

In the preferred embodiment of the disclosure, several sensors are assigned to each supply line, which are arranged at different points in the supply line or on the associated applicator. It should also be mentioned that the various sensors can also detect different measured variables, for example the flow rate (volumetric flow or mass flow) or the pressure of the application agent. For example, two sensors can be arranged in a supply line in this way, but a larger number of sensors is also possible within the scope of the disclosure.

With regard to the type of sensor, the disclosure is not limited to specific sensor types. For example, pressure sensors can be used which measure a pressure of the application agent in the supply line or in the applicator. Furthermore, within the scope of the disclosure, it is possible to use material flow sensors that measure a material flow of the application agent that flows to the applicator in the respective supply line. For example, the mass flow or the volumetric flow of the application agent flowing in the respective supply line to the associated applicator can be measured in this way.

In addition, the application system according to the disclosure preferably comprises at least one actuator which is used to control the supply line and/or the applicator and is controlled by a control signal. In the preferred embodiment of the disclosure, the monitoring unit also detects the control signal for the actuator and evaluates the control signal during the evaluation of the sensor signal in order to be able to distinguish a different actuation of the applicator from a creeping nozzle clogging. This means that the sensor signal is not only influenced by a creeping nozzle clogging, but is also significantly determined by the control of the applicator by the actuator. To detect a creeping nozzle clogging, the monitoring unit must therefore eliminate the influence of the actuator control from the sensor signal so that the remaining signal (“residual value”) then allows a statement to be made about a possible creeping nozzle clogging.

The disclosure is not limited to certain actuator types with regard to the type of actuator. For example, the actuator can be a control valve that controls the application agent flow to the applicator or to the individual nozzles, with the respective control signal determining the valve position of the respective control valve. Alternatively, it is possible that the at least one actuator is a pump that pumps an application agent flow to the applicator, whereby the respective control signal controls the application agent flow delivered by the respective pump.

It should also be mentioned that several actuators are assigned to each supply line, each of which is controlled by a control signal. For example, a pump and a control valve can be arranged as actuators in each supply line, which are controlled by different control signals. With such an arrangement of several actuators in the supply lines, the monitoring unit then preferably detects the control signals for all actuators and takes these into account when detecting a creeping nozzle clogging.

In the variant of the disclosure described above of an applicator with several nozzles, for example, a control valve can be provided for each nozzle as an actuator, which controls the flow of application agent through the respective nozzle. The monitoring unit then records the control signals for the various control valves and takes these control signals into account when detecting a possible creeping nozzle clogging.

When evaluating the sensor signals, the monitoring unit preferably takes into account an observation period after a switching time of the control valves. For example, the observation period can be triggered by the opening of a control valve of a nozzle. Alternatively, however, it is also possible for the observation period to be triggered by the closing of a control valve. This temporal reference of the evaluation of the sensor signal to the switching times of the control valves for the individual nozzles is useful in order to create comparable application conditions when comparing the sensor signals.

In the preferred embodiment of the disclosure, the monitoring unit comprises an AI computer (AI: Artificial Intelligence) on which a machine learning algorithm runs during operation. The machine learning algorithm then evaluates the at least one sensor signal and preferably also the at least one control signal and recognizes whether one of the nozzles shows a creeping nozzle clogging. For example, known software can be used for this, such as TensorFlow®, PyTorch® or Scikit-Learn®, which is freely available commercially.

In the preferred embodiment of the disclosure, the machine learning algorithm learns the relationship between the control signal on the one hand and the resulting sensor signal on the other in a training process through supervised learning for a proper operating state without a nozzle clogging. In application mode, the machine learning algorithm can then calculate a residual value from the measured sensor signal, from which the influence of the control signal is removed. The monitoring unit can then evaluate the residual value in application mode and recognize an anomaly in the residual value as an indication of a creeping nozzle clogging. For example, such an anomaly may be that the application pressure shows an unexpected increase that is not caused by the control signals and indicates a creeping nozzle clogging.

It has already been mentioned above that the monitoring unit preferably determines the sensor signals in an observation period following the switching times of the control valves of the individual nozzles. The above-mentioned residual values are then preferably evaluated in the observation period following the switching times.

For example, the monitoring unit can compare the residual values after the switching times of different nozzles in order to detect a creeping nozzle clogging. The evaluation therefore preferably not only takes into account the temporal progression of the sensor signals for the different nozzles independently of each other. Rather, the sensor signals or the residual values for the different nozzles are preferably also compared with each other in order to detect a creeping nozzle clogging that only occurs in a single nozzle, so that the cross-nozzle comparison of the sensor signals or the resulting residual values facilitates the detection of such a single nozzle clogging. Fluctuations in the application pressure (e.g. as a result of viscosity changes) always affect all nozzles, so that individual blockages can nevertheless be detected within the scope of the disclosure.

It should also be mentioned that the application system according to the disclosure preferably comprises an application robot to move the applicator. The application robot is preferably controlled by a robot controller, as is known from the prior art.

It should also be noted that the application system according to the disclosure can have several application robots, each of which moves an applicator. The individual application robots are preferably each controlled by a robot controller.

The application robots can be arranged together in a robot cell (e.g. application cabin). A cell controller can be provided for the comprehensive and coordinating control of the application robots within the robot cell, whereby the cell controller controls the robot controllers and/or the application robots in the robot cell in a comprehensive manner. This makes it possible to coordinate the application work of the various application robots within the robot cell.

Furthermore, the application system according to the disclosure can have a connectivity computer, whereby the connectivity computer is connected on the one hand to the robot controllers and/or to the cell controller and receives the control signals and the sensor signals from the robot controllers and/or the cell controller. On the other hand, the connectivity computer is preferably connected to the AI computer and supplies the AI computer with the control signals and the sensor signals for the actual evaluation and also for the preceding training process.

Furthermore, the application system according to the disclosure can have a database computer in order to store the control signals and the measured sensor signals in an assignment to one another. Preferably, this database computer is connected to the connectivity computer and receives the control signals and the sensor signals from the connectivity computer.

Furthermore, a graphics computer can be provided to display the result of the representation graphically, for example on a screen. The graphics computer is preferably connected to the connectivity computer and/or the database computer.

It has already been mentioned above that the disclosure comprises two disclosure variants, which are different. In a first variant of the disclosure, a supply line is provided which supplies an applicator with the application agent, the applicator having a plurality of nozzles. The disclosure then enables the detection of a creeping nozzle clogging in one of the nozzles of the applicator, which is made possible by a cross-nozzle comparison. In a second variant of the disclosure, on the other hand, several applicators are provided, each of which is supplied with the application agent to be applied from a supply line, whereby the individual applicators can optionally have one or more nozzles. Here too, the disclosure makes it possible to detect a creeping nozzle clogging in one of the nozzles, whereby a cross-nozzle comparison is again possible. The disclosure thus preferably provides for a cross-nozzle comparison between different nozzles, which can be located either on the same applicator or on different applicators.

In addition to the application system according to the disclosure described above, the disclosure also comprises a corresponding monitoring method for such an application system. The individual process steps of the monitoring method according to the disclosure are already apparent from the above description of the application system according to the disclosure, so that a separate description of the individual process steps of the monitoring method according to the disclosure can be dispensed with and reference is made to the above description of the application system according to the disclosure.

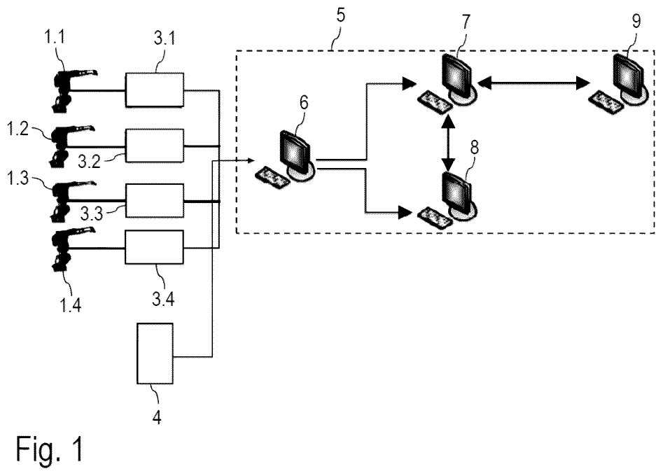

The schematic representation shown in FIG. 1 is described below, which shows a robot cell that is used in a paint shop for painting vehicle body components for sealing sheet metal seams.

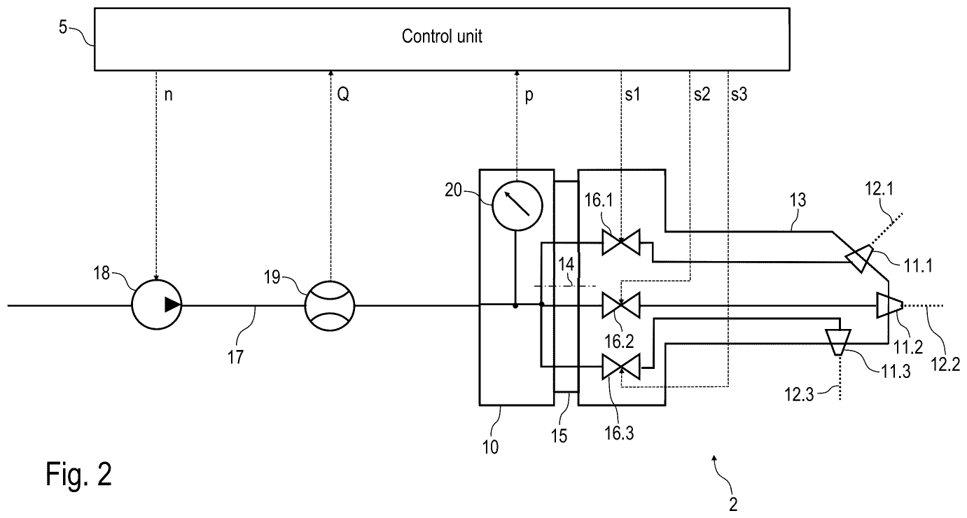

Four application robots 1.1-1.4 are arranged in the robot cell, each of which guides an applicator 2, as shown in FIG. 2 and described in detail later. Each of the four application robots 1.1-1.4 therefore guides an applicator 2, whereby the applicators 2 are not visible in FIG. 1.

The application robots 1.1-1.4 are each conventionally controlled by a robot controller 3.1-3.4.

In addition, the robot cell shown has a cell controller 4, which enables comprehensive and coordinating control of the four application robots 1.1-1.4. For this purpose, the cell controller 4 is connected to the four robot controllers 3.1-3.4.

In addition, the cell controller 4 has a monitoring unit 5, which has various tasks. On the one hand, the monitoring unit 5 controls the robot controllers 1.1-1.4, as is known from the prior art. On the other hand, the monitoring unit 5 is also intended to detect a creeping nozzle clogging in the nozzles of the applicators of the individual application robots 1.1-1.4, as will be described in detail later.

For this purpose, the monitoring unit 5 initially has a connectivity computer 6, which is connected to the robot controllers 3.1-3.4 and to the cell controller 4.

Furthermore, the monitoring unit 5 contains a database computer 7 for storing the recorded control signals and the sensor signals, as will be described in detail.

Furthermore, the monitoring unit 5 also contains an AI computer 8, on which a machine learning algorithm runs during operation, which makes it possible to detect a creeping nozzle clogging, as will be described in detail.

Finally, the monitoring unit 5 also contains a graphics computer 9, which has the task of graphically displaying the result of the monitoring.

In this embodiment example, the connectivity computer 6, the database computer 7, the AI computer 8 and the graphics computer 9 are shown as separate computers. However, within the scope of the disclosure, it is also possible for the functionalities of these computers to be integrated into a single computer or otherwise distributed to different computers.

The drawing according to FIG. 2 is now described below, which shows the applicator 2 as it is attached to the individual application robots 1.1-1.4. For this purpose, the applicator 2 first has a mounting flange 10, which is attached to a corresponding mounting flange of the respective application robot 1.1-1.4.

Furthermore, in this embodiment example, the applicator 2 has three nozzles 11.1-11.3, each of which can emit a jet 12.1-12.3 of the application agent.

The nozzles 11.1-11.3 are arranged in an applicator head 13, whereby the applicator head 13 can be rotated relative to the mounting flange 10 about an rotary axis 14.

The applicator head 13 is connected to the mounting flange 10 via a rotary feed-through 15. The rotary feed-through 15 allows the application agent to be fed from the mounting flange 10 to the applicator head 13 and the nozzles 11.1-11.3 arranged therein.

There are several control valves 16.1-16.3 in the applicator head 13, which can control the flow of the application agent to the individual nozzles 11.1-11.3 independently of each other. The control valves 16.1-16.3 are controlled by control signals s1-s3 from the monitoring unit 5, as shown here only schematically. In practice, the control valves 16.1-16.3 can be controlled electro-pneumatically. This means that the monitoring unit 5 first outputs electrical control signals, which then control pneumatic valves, whereby the pneumatic valves then in turn control the control valves 16.1-16.3. However, the way in which the control valves 16.1-16.3 are controlled is not of particular importance for the disclosure. For the sake of simplicity, the drawing therefore shows direct actuation of the control valves 16.1-16.3 by the monitoring unit 5.

The drawing also shows a supply line 17, which leads to the applicator 2 and supplies the applicator 2 with the application agent to be applied.

A pump 18 is arranged in the supply line 17, which pumps the application agent through the supply line 17 to the applicator 2, whereby the pump 18 is controlled by the monitoring unit 5 with a control signal n, which determines the pump speed of the pump 18 and thus its delivery rate.

In addition, a volumetric flow sensor 19 is arranged in the supply line 17, which measures the volumetric flow that flows in the supply line 17 to the applicator 2. The volumetric flow sensor 19 then outputs a corresponding sensor signal Q to the monitoring unit 5, whereby the sensor signal Q reflects the measured volumetric flow.

A pressure sensor 20 is also located in the mounting flange 10 of the applicator 2, which measures the pressure of the application agent in the supply line 17 inside the applicator 2 and outputs a corresponding sensor signal p to the monitoring unit 5.

The monitoring unit 5 therefore detects the sensor signals p, Q and outputs control signals n, s1-s3. By evaluating the sensor signals p, Q on the one hand and the control signals n, s1-s3 on the other, the monitoring unit 5 can then detect a creeping nozzle clogging in the individual nozzles 11.1-11.3, as will be described in detail below.

The monitoring unit 5 can evaluate the sensor signals p, Q within an observation period after a switching time of the control valves 16.1-16.3 and independently of each other for the different nozzles n, s1-s3. This then enables a cross-nozzle comparison between the sensor signals p, Q, which are recorded when the individual control valves 16.1-16.3 are opened.

It has already been mentioned above that the sensor signals p, Q are not only influenced by a slow nozzle clogging, but are also essentially determined by the control signals n, s1-s3. To detect a creeping nozzle clogging, it is therefore important to calculate the influence of the control signals n, s1-s3 from the sensor signals p, Q. This is done by a machine learning process. This is done using a machine learning algorithm as part of a supervised learning process during a training procedure, which is described in detail below.

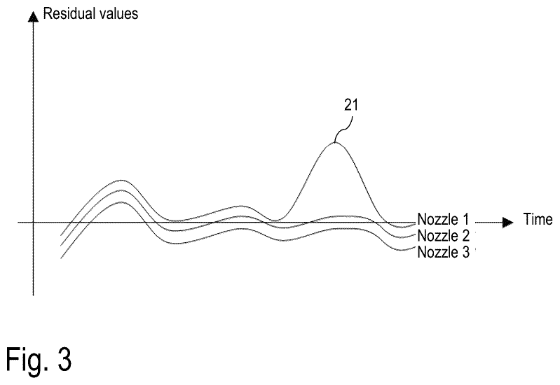

FIG. 3 shows the progression of residual values for the three nozzles 11.1-11.3, whereby the residual values are calculated by subtracting the influence of the control signals n, s1-s3 from the sensor signals p, Q. The residual values therefore only provide information on the control signals n, s1-s3. The residual values therefore only reflect the influence of a possible creeping nozzle clogging. FIG. 3 shows an anomaly 21 for the first nozzle 11.1, which is caused by a creeping nozzle clogging at nozzle 11.1.

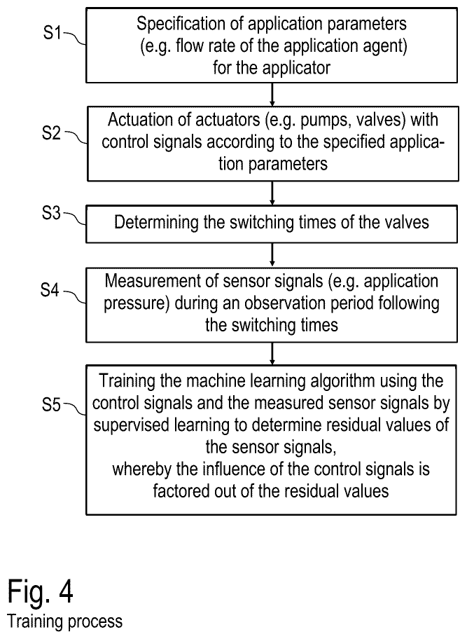

In the following, the embodiment according to FIG. 4 is described, which explains the training process of the machine learning algorithm that runs on the AI computer 8.

In a first step S1, application parameters are specified, such as the volumetric flow of the application agent.

In a second step S2, the various actuators are then controlled with control signals n, s1-s3 in accordance with the specified application parameters. In the example shown in FIG. 2, the actuators are the pump 18 and the control valves 16.1-16.3, which are controlled by the control signal n or the control signals s1-s3.

In the next step S3, the switching times of the control valves 16.1-16.3 are then determined so that sensor signals can be measured in an observation period following the switching times, which takes place in step S4. In the embodiment example according to FIG. 2, the sensor signals are the sensor signals p, Q of the volumetric flow sensor 19 or the pressure sensor 20.

In step S5, the machine learning algorithm is then trained using the control signals n, s1-s3 on the one hand and the sensor signals p, Q on the other. This training takes place within the framework of so-called supervised learning, as is known in the field of artificial intelligence. This training process is used to calculate the residual values from the sensor signals, from which the influence of the control signals n, s1-s3 is calculated.

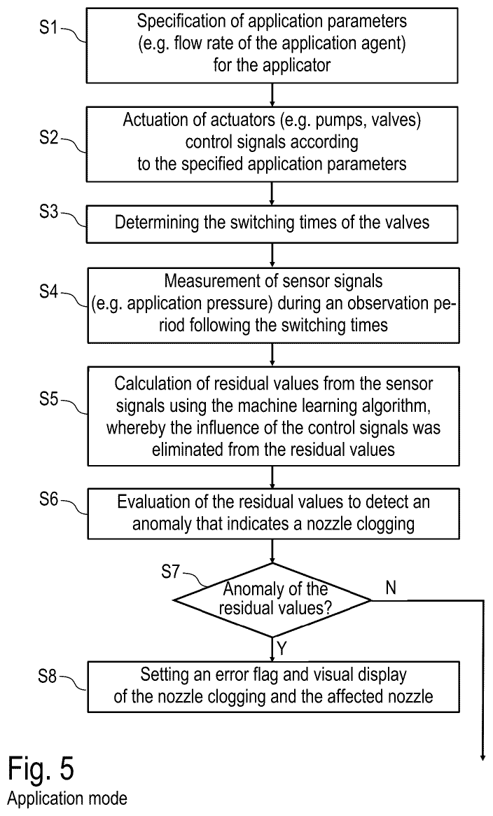

The flow chart shown in FIG. 5, which illustrates the actual application operation, is described below.

In a first step S1, application parameters are again specified. In the embodiment example shown in FIG. 2, for example, the desired volumetric flow of the application agent can be specified so that the pump 18 can then be controlled with a corresponding control signal n. In addition, switching times can be specified for the individual control valves 16.1-16.3 so that the control valves 16.1-16.3 can then be actuated with corresponding control signals s1-s3.

In the next step S2, the actuators are then controlled with control signals in accordance with the specified application parameters. In the embodiment example shown in FIG. 2, the actuators are the control valves 16.1-16.3 and the pump 18.

In the next step S3, the switching times of the control valves 16.1-16.3 are determined.

In a further step S4, the sensor signals p, Q are then measured in an observation period following the switching times.

Residual values are then calculated from the measured sensor signals p, Q by subtracting the influence of the control signals n, s1-s3 from the sensor signals p, Q. This is done using the machine learning algorithm in the AI computer 8.

In the next step S6, the residual values are then evaluated in order to detect any anomaly 21 that indicates a nozzle clogging.

If such an anomaly 21 (see FIG. 3) is detected in a step S7, an error flag is set in a step S8 and a visual display of the nozzle clogging and the affected nozzle is shown on the graphics computer 9.

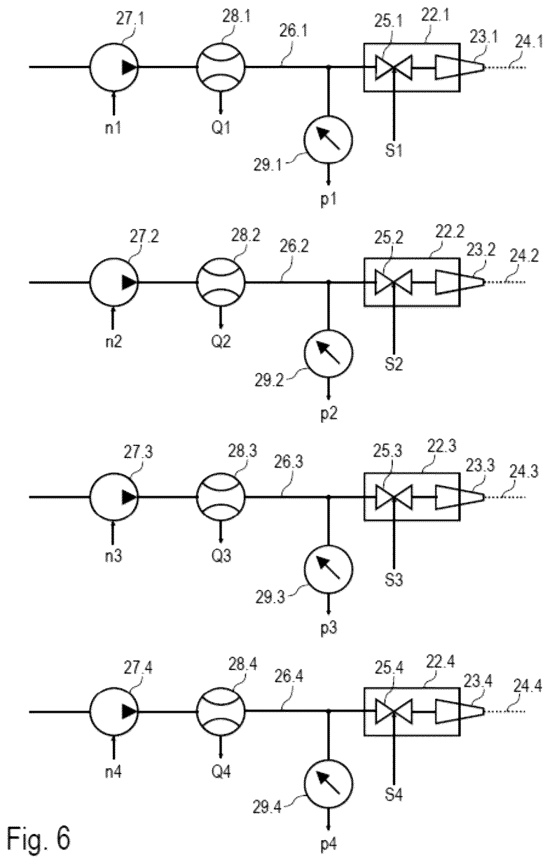

It has already been mentioned above that the disclosure comprises two different variants. The first variant with the applicator 2 with the multiple nozzles 11.1-11.3 was described above and is shown in FIG. 2. However, the also comprises another variant of the, which is shown in FIG. 6 and is briefly described below.

In this variant of the disclosure, a plurality of applicators 22.1-22.4 are provided, each having a nozzle 23.1-23.4, wherein the individual nozzles 23.1-23.4 can each deliver a jet 24.1-24.4 of the application agent. For example, the individual applicators 22.1-22.4 can each be guided by an application robot.

A control valve 25.1-25.4 is located in each of the individual applicators 22.1-22.4 in order to control the flow of the application agent to the respective nozzle 23.1-23.4.

The individual applicators 22.1-22.4 are each supplied with the application agent by a supply line 26.1-26.4.

In each of the individual supply lines 26.1-26.4 there is a controllable pump 27.1-27.4, which pumps the application agent to the associated applicator 22.1-22.4. The individual pumps 27.1-27.4 are each controlled by control signals n1-n4, which determine the pumping capacity of the pumps 27.1-27.4

In addition, a volumetric flow sensor 28.1-28.4 is located in each of the individual supply lines 26.1-26.4, whereby the volumetric flow sensors 28.1-28.4 measure the volumetric flow of the application agent to the individual applicators 22.1-22.4 and output a corresponding sensor signal Q1-Q4 in each case.

A pressure sensor 29.1-29.4 is located in each of the individual supply lines 26.1-26.4 shortly before the individual applicators 22.1-22.4, whereby the pressure sensors 29.1-29.4 measure the pressure of the application agent in the respective supply line 26.1-26.4 shortly before the applicator 22.1-22.4 and output a corresponding sensor signal p1-p4.

In this variant of the disclosure, a creeping nozzle clogging in the individual nozzles 23.1-23.4 can also be detected by the monitoring unit 5 in the manner described above. For this purpose, the monitoring unit 5 then evaluates the control signals s1-s4, n1-n4 and the sensor signals p1-p4 and Q1-Q4, as described above. Here, too, the disclosure enables a cross-nozzle comparison between the various nozzles 23.1-23.4 in order to be able to recognize when one of the nozzles 23.1-23.4 shows a creeping nozzle clogging.

1.-18. (canceled)

19. An application system for applying an application agent to a component, with
a) an applicator with at least one nozzle for applying the application agent to the component,
b) a supply line for supplying the applicator with the application agent,
c) a sensor which is adapted to measure a measured variable in the supply line to the applicator or in the applicator and supplies a corresponding sensor signal, and
d) a monitoring unit which is connected to the sensor and evaluates the sensor signal of the sensor,
e) wherein the monitoring unit recognizes by evaluating the sensor signal whether one of the nozzles of the applicator shows a creeping nozzle clogging.

20. The application system according to claim 19, wherein the at least one sensor belongs to one of the following types of sensors:
a) pressure sensors which are adapted to measure a pressure of the application agent in the supply line or in the applicator,
b) material flow sensors which are adapted to measure a material flow of the application agent flowing in the supply line to the applicator.

21. The application system according to claim 19, wherein
a) the application system comprises at least one actuator for controlling the supply line and/or the applicator,
b) the actuator is controlled by a control signal, and
c) the monitoring unit detects the control signal for the actuator and takes it into account in the evaluation of the sensor signal in order to distinguish a different actuation of the applicator from a creeping nozzle clogging.

22. The application system according to claim 21, wherein the at least one actuator belongs to one of the following types of actuators:
a) control valves which control an application agent flow to the individual nozzles, the respective control signal controlling the valve position of the respective control valve,
b) pumps which deliver an application agent flow to the applicator pumps, wherein the respective control signal controls the application agent flow delivered by the respective pump.

23. The application system according to claim 21, wherein
a) each of the nozzles of the applicator is assigned a respective control valve as actuator, which controls the application agent flow through the respective nozzle,
b) the control valves are each actuated by a control signal which controls the switching time of the respective control valve,
c) the monitoring unit receives the control signals for the individual control valves in order to be able to compare the nozzles with one another and to detect a creeping nozzle clogging, and
d) the monitoring unit evaluates the sensor signals in an observation period after a switching time of the control valves.

24. The application system according to claim 19, wherein
a) the monitoring unit comprises an AI computer on which a machine learning algorithm runs during operation, and
b) the machine learning algorithm is adapted to evaluate the sensor signal and also the control signal and recognizes whether one of the nozzles shows a creeping nozzle clogging.

25. The application system according to claim 24, wherein
a) the machine learning algorithm is adapted to learn the relationship between the control signal and the resulting sensor signal in a training process by supervised learning without a nozzle clogging,
b) the machine learning algorithm in application mode calculates a residual value from the measured sensor signal, from which the influence of the control signal is subtracted, and
c) the monitoring unit is adapted to evaluate the residual value and recognizes an anomaly of the residual value as an indication of a creeping nozzle clogging.

26. The application system according to claim 25, wherein
a) the monitoring unit is adapted to determine switching times of the control valves of the individual nozzles, and
b) the monitoring unit is adapted to evaluate the residual values in each case in an observation period following the switching times.

27. The application system according to claim 25, wherein the monitoring unit is adapted to compare the residual values after the switching times of different nozzles in order to detect a creeping nozzle clogging.

28. The application system according to claim 19, further comprising
a) an application robot for moving the applicator, and
b) a robot controller for controlling the application robot.

29. The application system according to claim 28, wherein
a) several application robots are provided, each of which moves an applicator,
b) the individual application robots are each controlled by a robot controller,
c) the application robots are arranged together in a robot cell, and
d) a cell controller is provided for controlling the robot cell, wherein the cell controller controls the robot controllers and/or the application robots in the robot cell in a comprehensive manner.

30. The application system according to claim 29, further comprising a connectivity computer,
a) the connectivity computer being connected on the one hand to the robot controllers and/or the cell controller and receiving the control signals and the sensor signals from the robot controllers and/or the cell controller,
b) while the connectivity computer, on the other hand, is connected to the AI computer and supplies the control signals and the sensor signals to the AI computer.

31. The application system according to claim 29, further comprising:
a database computer for storing the control signals and the sensor signals, wherein the database computer is connected to the connectivity computer and receives the control signals and the sensor signals from the connectivity computer.

32. The application system according to claim 30, further comprising:
a graphics computer for displaying the result of the evaluation, wherein the graphics computer is connected to the connectivity computer or the database computer.

33. The application system according to claim 19, wherein
a) several applicators are provided,
b) a plurality of supply lines are provided for supplying the applicators with the application agent, one of the supply lines being assigned to each of the applicators,
c) at least one of the sensors is assigned to each of the supply lines and the sensors each measure a measured variable in the respective supply line and supply a corresponding sensor signal,
d) the monitoring unit compares the sensor signals from sensors from different supply lines with one another in order to distinguish a creeping nozzle clogging in the individual supply lines from a different actuation of the respective supply line,
e) at least one of the actuators is assigned to each of the supply lines, and
f) the monitoring unit takes into account the control signals for actuators in different supply lines in order to distinguish a creeping nozzle clogging in the individual supply lines from a different actuation of the respective supply line.

34. A monitoring method for an application system according to claim 19, comprising the following steps:
a) supplying the application agent to the applicator through the supply line,
b) measuring at least one measured variable in the supply line to the applicator or in the applicator by means of the sensor and generating a corresponding sensor signal, and
c) evaluating the sensor signal to detect a creeping nozzle clogging of one of the nozzles of the applicator.

35. The monitoring method according to claim 34, further comprising the following steps:
a) actuating the supply line and/or the applicator with a control signal, and
b) evaluation of the control signal to distinguish a creeping nozzle clogging from a different actuation.

36. The monitoring method according to claim 34, wherein
a) the machine learning algorithm learns the relationship between the control signal and the resulting sensor signal in a training process by supervised learning without a nozzle clogging,
b) the machine learning algorithm in application mode calculates a residual value from the measured sensor signal, from which the influence of the control signal is subtracted, and
c) the monitoring unit evaluates the residual value and recognizes an anomaly of the residual value as an indication of a creeping nozzle clogging.

37. The monitoring method according to claim 36, wherein
a) that the monitoring unit determines the respective switching times of the control valves of the individual nozzles, and
b) that the monitoring unit evaluates the residual values in each case in an observation period following the switching times.

38. The monitoring method according to claim 37, wherein the monitoring unit compares the residual values of different nozzles with one another in order to detect a creeping nozzle clogging.
